(19) United States
(12) Patent Application Publication
(10) Pub. No.: US 2018/0158120 A1
(43) Pub. Date: Jun. 7, 2018

(54) SYSTEM AND METHOD FOR DISPLAYING AND CATALOGING STAMP COLLECTIONS

(71) Applicant: RICHARD LEHMANN, BOCA RATON, FL (US)

(72) Inventor: RICHARD LEHMANN, BOCA RATON, FL (US)

(21) Appl. No.: 15/369,924

(22) Filed: Dec. 6, 2016

(51) Int. Cl. G06Q 30/06; G06Q 10/08; G06Q 30/02; G06Q 40/06

(52) U.S. Cl. CPC G06Q 30/0603; G06Q 30/0625; G06Q 40/06; G06Q 10/087; G06Q 30/0278; G06Q 30/0633

(57) ABSTRACT

The albums of the current philatelic or stamp collecting industry serve only as a way to make displaying stamps easier and more attractive visually. The method and system of the present invention allows for electronically displaying, cataloguing, buying and bidding stamp collections to allow postage stamp collectors, buyers and sellers to upload, search and receive information related to the postage stamps of their interest. The present invention comprises, inputting digitized stamp information from an input device and storing the digitized information related to the postage stamps in a database, a processor for processing the stored information of the individual stamps, an display for electronically searching and displaying the processed stored information of the individual stamps, and a transmitter, intranet or internet to transmit the information of the one or more stamps for further processing or displaying the transmitted information in response to a query.

### FIELD OF THE INVENTION

This invention relates generally to a field of universal stamp collection and stamp management method and system and, more particularly, to an electronic universal stamp collection and stamp management method and system facilitating online stamp market globally.

### BACKGROUND OF THE INVENTION

The philatelic or stamp collecting hobby has, as its major method of accumulating a collection of stamps, the use of published albums where the collector mounts his stamps in a pre-printed album pages with identified spaces on each page for placing a given stamp. Most such album pages are laid out in chronological order by country. Frame lines define the size, shape and some identifying feature of each stamp so that the correct stamp is put in that place. Once a stamp is mounted in its prescribed space all descriptive information is covered up. Hence, in order for a collector to obtain a valuation of his collection, he must consult a catalog and prepare a manual list with which to then look up the catalog price or current market valuation. Likewise, in order to search for the items still missing in his collection, known as the “Want List”, the collector must similarly first prepare a manual list. Other drawbacks to this system are that it provides for no indication of the state of the stamp, i.e. is it unused or used; and it provides for no description of the condition of the stamp, i.e. is it a superb, very fine, fine or poor copy. These judgmental factors play a major role in how a stamp is valued by a buyer or seller. In short, albums currently serve only as a way to make displaying stamps easier and more attractive visually. This shortcoming over what could be done has not been addressed because the industry has been slow to adopt bar coding technology and constrained by catalog companies through the licensing of their numbering systems.

Stamp identification and valuation is, of past necessity, done via a catalog identification system. Stamps are identified by catalog numbers which were established over a hundred years ago and are not computer friendly, nor do they follow a universal protocol for identifying an item among the various major and minor catalog publishers. There are four common systems (Scott, Michel, Yvert and Gibbons) which attempt to identify the entire universe of stamps and there are dozens of country and regional catalogs which address individual countries, regions and specialties. None of the big four systems come close to identifying the universe, in fact, they don't even agree on which items to include. They also do not accommodate identification of stamps by topic, a more recent collecting activity. They are constrained by the page count problem, i.e. a broader inclusion would easily double the size of what is already an overwhelming publication. Their valuations are based on a variety of sources of which true market prices is only reflected in the pricier items traded at auction. They inflate market prices to accommodate dealers' ability to haggle with buyers and give the appearance that a bargain is being offered.

The Internet has been the salvation of philately or, as others believe, it has just extended its death throes. We believe in the salvation theory and hold that the industry has only scratched the surface of what can be done. Stamp dealing remains a cottage industry due to a failure to develop the tools to break out of the traditional trading model.

A basic assumption in our effort is that stamp selling has only embraced a fraction of the opportunities that computerization and the Internet offer the hobby. What we have today is a market place on the Internet which tries to emulate the old time business model of stamp shows where hundreds of dealers congregate in one place where collectors can come and peruse their offerings and haggle over quality and price. The Internet market instead offers thousands of websites where collectors can view hundreds of dealers' offerings, view images of the offerings and compare prices. The haggling can still take place electronically, albeit losing some of the charm many find in the personal interaction. Still and all, this change has been a lifesaver to an industry whose death has been predicted for the last 50 years.

The industry survives on a cycle of stamp turnover driven by the death of older collectors and the buying by younger ones whose economic well being allows them to expand the scope of their collecting activity. The survival problem comes from the fact that the rate of collectors dying is greater than of new collectors joining or increased buying by existing ones. Add to this the fact that the quantity of existing stamps remains fairly static and you have an industry where available supply is increasing at a faster rate than demand. As a result, for the vast majority of stamps, their value does not increase at more than the rate of inflation, if even that. The Internet has allowed dealers to sell more and thereby, overcome a slow death spiral, but things need not be this way.

The Internet offers a huge opportunity for attracting new collectors from areas of the world where stamp collecting is practically unknown but its natural and economic appeal make it attractive. Thus an effort is needed

It is an object of this invention to provide an electronic universal stamp collection and stamp management method and system to facilitate online stamp market globally and to overcome the above problems of the prior art.

It is apparent now that numerous innovations have been provided in prior art that are adapted to stamp collection methods and systems. Even though the existing methods and systems may be suitable for the specific purposes to which they address, however, they would not be as suitable for the purposes of the present invention. The proposed system is designed to overcome the above described shortcomings of the current album system and actually expand their purpose and scope. It is also a tool that can be used in the industry to drastically reduce the labor needed to prepare stamp inventories for resale independent of its use in pre-printed albums. Thus there is a need to change the way stamps are bought and sold in some very profound and disruptive ways in the belief that these changes will truly enhance stamp collecting industry and grow the hobby.

### SUMMARY OF THE INVENTION

The present invention discloses about an electronic universal stamp collection and stamp management method and system to facilitate online philately market globally. One objective of the present invention is to provide an electronic postage stamps system comprises, an interface to input and store information related to postage stamps; a means for processing the stored information of the individual stamps; an interface for electronically searching and displaying the processed stored information of the individual stamps; and a transmission means to transmit the information of the one or more stamps for further processing or displaying the transmitted information in response to a query.

In view of the foregoing, it is therefore another object of the present invention allows postage stamp collectors, buyers and sellers to upload, search and receive information related to the postage stamps of their interest.

It is still another object of the present invention to provide an input interface that allows to input QR codes or barcodes for all the stamps in an album or pre-printed pages or a computer file along with spaces to input descriptive information on each of the stamps, preparing an electronic database of the stamp collection by scanning individual pages of an album or inventory pages or electronic file and to input an electronic “Want List” of stamps missing from the collection.

It is further another object of the present invention to provide an identification protocol also known as a name directory database that allows the integration of all stamp offerings and individual stamp images by one or more dealers into one searchable database.

It is further another object of the present invention to provide a storage means that stores in a database the attributes of individual stamps, investment rating information, pricing information, bidding information, want list, offerings and other related information of the individual stamps.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The invention will now be described, by way of example, with reference to the accompanying drawings, in which:

FIG. 1 illustrates a block diagram of an electronic universal stamp collection and stamp management system facilitating online stamp market globally in accordance with an embodiment of the present invention;

FIG. 2 illustrates network diagram of an electronic universal stamp collection with other systems and systems of the stamp dealers facilitating quick, easy and competitive online stamp market globally in accordance with an embodiment of the present invention; and

FIG. 3 illustrates a flow chart describing an electronic universal stamp collection and stamp management method facilitating online stamp market globally in accordance with another embodiment of the present invention.

Like reference numerals refer to like parts throughout the various views of the drawings.

### DETAILED DESCRIPTION OF THE INVENTION

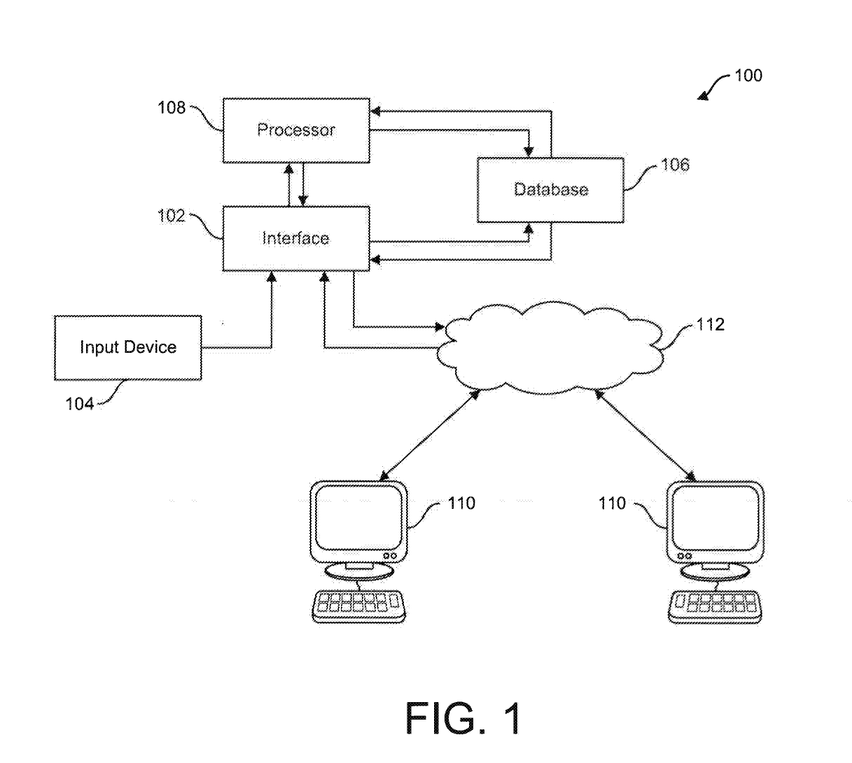

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rearward,” “right,” “forward,” “vertical,” “horizontal,” and derivatives thereof shall relate to the invention as oriented in FIGS. 1-3. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

The present system is based on a universal stamp identification system and stamp database management system which allows the creation of a unique QR code for every philatelic item. The QR code would be printed on album pages sold by various companies in the philatelic industry. The album buyer would use the pages to mount their collection and provide type and condition information through selecting pre-populated choices.

In order to obtain one or more services of the present invention, the collector would submit page scans of the collection. The present invention, through its proprietary software and databases, read the QR codes on each album page and prepare the requested information or take the specified actions requested. All of these technological embodiments have a common client-server architecture implemented in conjunction with an Internet site.

Universal stamp identification system creates a file structure that allows all stamps and philatelic items to reside in a single database and be recalled at will through a series of menu choices. Further the proposed delivery system of information of the present invention uses QR codes or barcodes through electronic albums. The present method and system overcomes all the shortcomings and adds greatly to the types of information that can be electronically gathered and disseminated.

In an embodiment of the present invention, the collector would purchase or create, from a software application, album pages with a framed space for location of each stamp and a space underneath where a QR or bar code identifies the stamp and check boxes that allow the specific characteristics of the displayed stamp to be noted. Characteristics such as whether the stamp is used or unused, the condition and quantity or the like can be mentioned in the provided space so as to facilitate better management and dissemination of the collected stamps without departing from the scope and spirit of the present invention. Thus the collector would mount his stamps as always, but taking the additional step of completing the characteristics information in an electronic and easily searchable form. At any time, the collector or his heirs can scan the pages and upload them to the database of the present invention in a view to facilitate informational services as per his requirement. Further the stamp collector may just want an appraisal of the collection and digital record for insurance purposes. He may also ask to have the missing items prepared into an electronic “Want List” for use in periodic, automatic searching and feedback of available items. The collection would be kept on file for future updating or eventual sale by the collector or his heirs. If sold to a dealer, it can easily be converted to a sales inventory with individual stamp images and listings with little additional manual data entry.

In an exemplary embodiment of the present invention an electronic universal stamp collection, stamp management and stamp commercialization method and system facilitating online stamp market globally is referenced in FIGS. 1-3.

FIG. 1 shows a block diagram illustrating an electronic postage stamps system 100 comprises, an interface or an web page 102 to input digitized stamp information from an input device 104 and store the digitized information related to the postage stamps in a database 106, a means such as a software program or a controller or a processor 108 for processing the stored information of the individual stamps, an interface or a web page 110 for electronically searching and displaying the processed stored information of the individual stamps, and a transmission means such as a transmitter, like telephone/wireless network, intranet or internet 112 to transmit the information of the one or more stamps for further processing or displaying the transmitted information in response to a query.

FIG. 1 in an alternate embodiment of the present invention further illustrating an electronic stamp system 100 allowing postage stamp collectors to receive information on their collection or provide such information to buyers and sellers, the system 100 comprises, an interface 102 to input codes (using bar or QR codes) for all the stamps on a catalog page along with spaces to input descriptive information on each of the stamp, preparing an electronic database 106 of the stamp collection by scanning individual pages of an album or an inventory and to derive therefrom an electronic “Want List” of stamps missing from the collection, the storage means or the database 106 stores attributes of individual stamps, investment rating information, pricing information, bidding information, want list, offerings and other related information of the individual stamps, a means such as a software program or a controller or a processor 108 for processing the stored information and the attributes of the individual stamps, an interface or a web page 110 for electronic searching the database 106 and displaying the processed stored information and the attributes of the individual stamps and feedback to the collector of the stamps, and a transmission means such as a transmitter, like intranet or internet 112 to transmit the attributes and/or the information of the one or more stamps for further processing or displaying the transmitted information in response to a query from the stamp collectors, buyers and/or the sellers.

In another embodiment of the invention, the system 100 allows postage stamp collectors, buyers and sellers to upload, search and receive information related to the postage stamps of their interest

In another embodiment of the invention, the input interface of the system allows to input QR codes or barcodes for all the stamps in an album or pre-printed pages or a computer file along with spaces to input descriptive information on each of the stamps, preparing an electronic database of the stamp collection by scanning individual pages of an album or inventory pages or electronic file and to input an electronic “Want List” of stamps missing from the collection.

In another embodiment of the invention, the system 100 comprises an identification protocol that allows the integration of all stamp offerings and individual stamp images by one or more dealers into one searchable database.

In another embodiment of the invention, the storage means system 100 stores digitized stamp information in a database comprising the attributes of individual stamps, investment rating information, pricing information, bidding information, want list, offerings and other related information of the individual stamps.

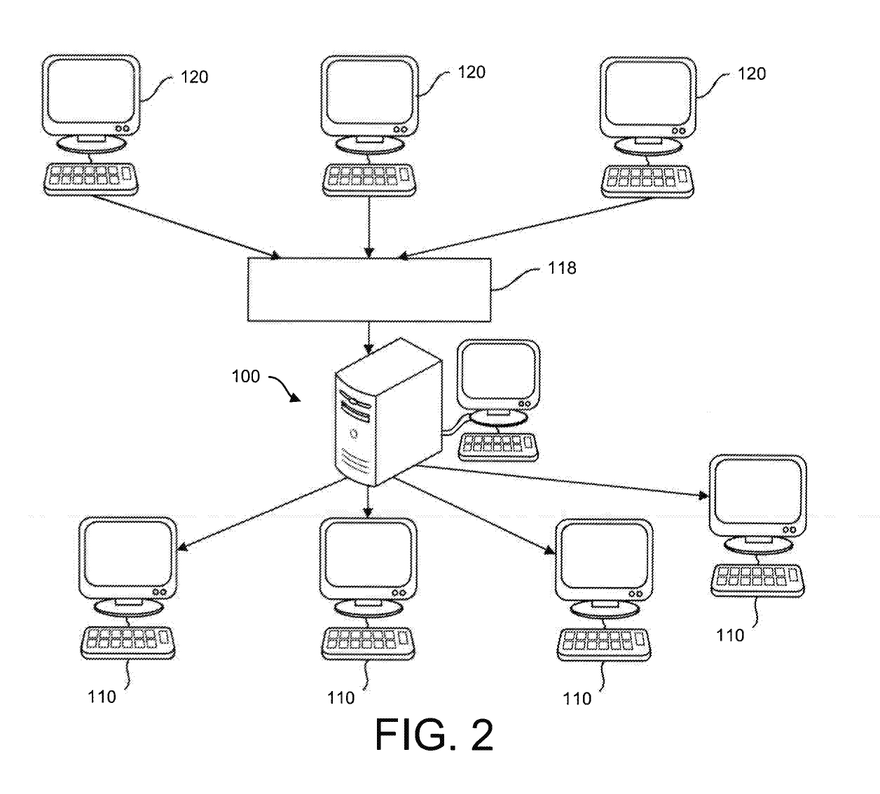

FIG. 2 shows a block diagram illustrating an electronic stamp system 100 connecting other systems, or different catalog publishers 120 to integrate available stamp offerings and individual stamp images into the electronic stamp system 100 via an identification protocol 118 such as a name directory database or the like, so as to store them into one searchable database of the system 100. This allows an interface 110 at dealers end to display their inventory on numerous multi-dealer stamp sales sites without special processing. But even more, the present system 100 allows the other systems, and different catalog publishers 120 to prepare an inventory for sale and then run it against the digital catalog of the present system 100 to provide recommended pricing based on the latest sales and “want list” information. This is a huge labor saving and avoids pricings which make an offering uncompetitive. In turn, such a pricing service will increase inventory turnover since it also allows for automatic re-pricing for slow moving items and allows a dealer to tag an offering with its investment grade rating. The present system 100 also provides for dealers system 110 and others such as publishers 120 to access file images of lower priced stamps based on the topic of the stamps where stamp condition is not an issue. The present system 100 allows quick, easy and competitive online stamp market globally in accordance with an embodiment of the present invention.

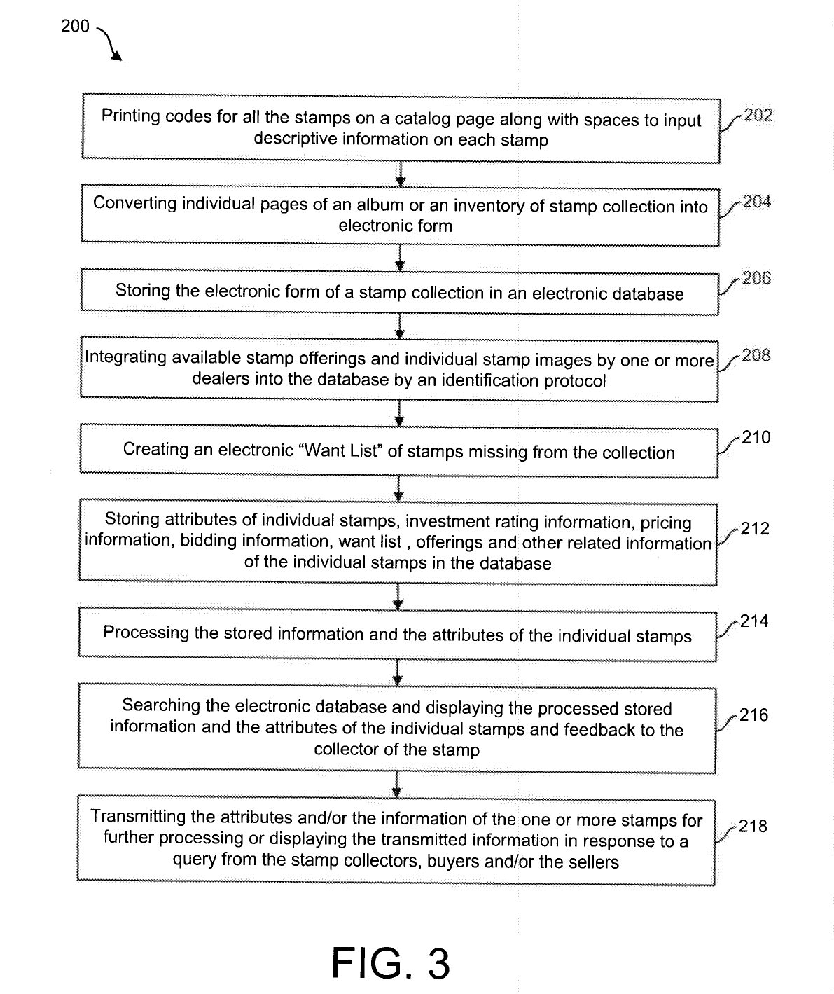

FIG. 3 shows a flow diagram illustrating a method 200 for electronically displaying and cataloguing stamp collections to allow postage stamp collectors, buyers and sellers to upload, search and receive information related to the postage stamps of their interest, the method 200 comprises printing codes for all the stamps on a catalog page along with spaces to input descriptive information on each stamp 202, converting individual pages of an album or an inventory of stamp collection into electronic form 204, storing the electronic form of a stamp collection in an electronic database 206, integrating available stamp offerings and individual stamp images by one or more dealers into the database by an identification protocol 208, creating an electronic “Want List” of stamps missing from the collection 210, storing attributes of individual stamps, investment rating information, pricing information, bidding information, want list, offerings and other related information of the individual stamps in the database 212, processing the stored information and the attributes of the individual stamps 214, searching the electronic database and displaying the processed stored information and the attributes of the individual stamps and feedback to the collector of the stamp 216 and finally transmitting the attributes and/or the information of the one or more stamps for further processing or displaying the transmitted information in response to a query from the stamp collectors, buyers and/or the sellers 218.

In an embodiment of the invention, the invention allows reduction of an album page or an inventory page into images of the individual stamps in the collection with an identifying image name along with the descriptive information on the album page.

In another embodiment of the invention, the invention allow the collectors offer the collection on the internet worldwide to any interested buyer accompanied by a detailed valuation and investment ratings.

In another embodiment of the invention, the invention allows the descriptive information to be provided within the space of each stamp provide specific characteristics of the stamp such as whether the stamp is used or unused, the condition and quantity of the stamp and the space also provides one or more check boxes that allow the specific characteristics of the stamp to be noted.

In another embodiment of the invention, the invention allows identification of the stamps by one of several catalog numbers, and/or by topic.

In another embodiment of the invention, the invention allows a basis for an insurance claim as well as a precise identification listing if a sale is attempted in case of theft of one or more stamps.

In another embodiment of the invention, the invention provides auction houses detailed information describing a collection with a single click of a button.

In another embodiment of the invention, the invention provides a dealer buyer of a collection a digital and hard copy inventory of the collection for seamless transmission to a sales site or for hard copy price lists without additional detailed manual inputting.

The present invention has developed a variety of tools to benefit the stamp buyer, be he a collector, investor or speculator to provide greatest opportunities to benefit from technology and the Internet for the whole philately industry. The catalog of the present invention allow status of stamps such as information about what is available, what it trades for and how good an investment it may be.

The present invention has created a want list service that takes the time out of searching multiple sites or the loss of opportunities due to not knowing what has become available before someone else. The present invention provides a service where an user indicates what he wants and even indicate how much he is willing to pay, i.e. a bid price. As often as he wishes, he can go to his private list and see what has come up which was previously not there. The user can also opt to receive an email when new listings he seeks appear or when an upcoming auction will be offering the item.

Further another feature being offered by the present invention provides collectors the ability to list their collections on the website or user interface of the present invention either in detail or by album pages. An album page listing will, for example, allow heirs to a collection to offer it to any buyer worldwide. It can also be shown, at the collectors' option for an appraisal in order to evaluate offerings. This is particularly valuable to heirs who have no idea what to accept as a fair price. But it is in the listing by a collector of his collection in detail with images of key items that offers the greatest value for eventual resale. A properly described collection can save a dealer hundreds of hours of labor in preparing it for resale. Such a collection can also be better evaluated for the value of the items the dealer knows are quickly saleable. All this translates into a higher offering price for the collection.

It is an advantage of the present invention to allow information to be maintained in a database that is being constantly updated so that current periodic reporting can be provided to a collector with no additional effort on their part. Hence, an album never goes out of date.

It is another advantage of the present invention to provide a stamp by stamp identification by one of several catalog numbers, and by topic. It also provides historical pricing, current market pricing and investment grade ratings.

It is another advantage of the present invention to provide accesses to a database that is not dependent on one single catalog identification system. Hence it can serve an international market where product availability and pricing can vary greatly by currency and by catalog.

It is another advantage of the present invention to provide a “Want List” feature, which allows for electronic searching and notification when stamps become available. It also allows the collector to submit a bid price rather than accept a static offer price. It further provides the collector with a recent history of what the stamp traded for and its investment grade rating.

It is another advantage of the present invention to allow a collector to sell his stamps to anyone worldwide based on the buyer being able to view the collection in detail along with an appraisal. Thus the system of the present invention acting as an intermediary in the sales transaction, a seller and a buyer can avoid a potential fraud by either seller or buyer.

It is another advantage of the present invention to allow a dealer buyer of a collection to convert the collection into individual inventory sales listings along with images without any significant manual data entry, a huge time savings and thereby, a value enhancer.

It is another advantage of the present invention to provide both the basis for an insurance claim as well as a precise identification listing if a sale is attempted in case of theft or misuse of a collection.

It is another advantage of the present invention to allow an auction house offering the collection for sale a more precise description and valuation of the collection in their sales catalog.

It is another advantage of the present invention to allow stamps to serve as a legitimate investment diversification for wealthy individuals, especially with the economic and currency uncertainty situations. Further a transparent stamp market will also attract speculators and investors for transactions into or out of nations with repressive governments or where banking systems don't allow free foreign exchange access.

These and other scope and advantages of the invention will be further understood and appreciated by those skilled in the art by reference to the written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An electronic postage stamps system comprises:
an interface to input and store information related to postage stamps;
a means for processing the stored information of the individual stamps;
an interface for electronically searching and displaying the processed stored information of the individual stamps; and
a transmission means to transmit the information of the one or more stamps for further processing or displaying the transmitted information in response to a query.

2. The system of claim 1, wherein the system allows postage stamp collectors, buyers and sellers to upload, search and receive information related to the postage stamps of their interest.

3. The system of claim 1, wherein the input interface of the system allows to input QR codes or barcodes for all the stamps in an album or pre-printed pages or a computer file along with spaces to input descriptive information on each of the stamps, preparing an electronic database of the stamp collection by scanning individual pages of an album or inventory pages or electronic file and to input an electronic “Want List” of stamps missing from the collection.

4. The system of claim 1, wherein the system comprises an identification protocol that allows the integration of all stamp offerings and individual stamp images by one or more dealers into one searchable database.

5. The system of claim 1, wherein the storage means stores in a database the attributes of individual stamps, investment rating information, pricing information, bidding information, want list, offerings and other related information of the individual stamps.

6. An electronic stamp system allowing postage stamp collectors to receive information on their collection or provide such information to buyers and sellers, the system comprises:
an interface to input codes for all the stamps on a catalog page along with spaces to input descriptive information on each of the stamp, preparing an electronic database of the stamp collection by scanning individual pages of an album or an inventory and thereby generating an electronic “Want List” of stamps missing from the collection;
a storage means to store attributes of individual stamps, investment rating information, pricing information, bidding information, want list, offerings and other related information of the individual stamps in the database;
a means for processing the stored information and the attributes of the individual stamps;
an interface for electronic searching the database and displaying the processed stored information and the attributes of the individual stamps and feedback to the collector of the stamps; and
a transmission means to transmit the attributes and/or the information of the one or more stamps for further processing or displaying the transmitted information in response to a query from the stamp collectors, buyers and/or the sellers.

7. The system of claim 6, wherein the system allows for the reduction of an album page or an inventory page into images of the individual stamps in the collection with an identifying image name along with the descriptive information on the album page.

8. The system of claim 6, wherein the collectors offer the collection on the internet worldwide to any interested buyer accompanied by a detailed valuation and investment ratings.

9. The system of claim 6, wherein the descriptive information provided within the space of each stamp provide specific characteristics of the stamp such as whether the stamp is used or unused, the condition and quantity of the stamp and the space provides one or more check boxes that allow the specific characteristics of the stamp to be noted.

10. The system of claim 6, wherein the system allows identification of the stamps by one of several catalog numbers, and/or by topic.

11. The system of claim 6, wherein the system allows a basis for an insurance claim as well as a precise identification listing if a sale is attempted in case of theft of one or more stamps.

12. The system of claim 6, wherein the system provides auction houses detailed information describing a collection with a single click of a button.

13. The system of claim 6, wherein the system provides a dealer buyer of a collection a digital and hard copy inventory of the collection for seamless transmission to a sales site or for hard copy price lists without additional detailed manual inputting.

14. A method for electronically displaying and cataloguing stamp collections to allow postage stamp collectors, buyers and sellers to upload, search and receive information related to the postage stamps of their interest, the method comprises:
printing codes for all the stamps on a catalog page along with spaces to input descriptive information on each stamp;
converting individual pages of an album or an inventory of stamp collection into electronic form;
storing the electronic form of a stamp collection in an electronic database;
integrating available stamp offerings and individual stamp images by one or more dealers into the database by an identification protocol;
creating an electronic “Want List” of stamps missing from the collection;
storing attributes of individual stamps, investment rating information, pricing information, bidding information, want list, offerings and other related information of the individual stamps in the database;
processing the stored information and the attributes of the individual stamps;
searching the electronic database and displaying the processed stored information and the attributes of the individual stamps and feedback to the collector of the stamp; and
transmitting the attributes and/or the information of the one or more stamps for further processing or displaying the transmitted information in response to a query from the stamp collectors, buyers and/or the sellers.

15. The method of claim 14, wherein the method allows for the reduction of an album page or an inventory page into images of the individual stamps in the collection with an identifying image name along with the descriptive information on the album page.

16. The method of claim 14, wherein the collectors offer the collection on the internet worldwide to any interested buyer accompanied by a detailed valuation and investment ratings.

17. The method of claim 14, wherein the descriptive information provided within the space of each stamp provide specific characteristics of the stamp such as whether the stamp is used or unused, the condition and quantity of the stamp and the space also provides one or more check boxes that allow the specific characteristics of the stamp to be noted.

18. The method of claim 14, wherein the method allows identification of the stamps by one of several catalog numbers, and/or by topic.

19. The method of claim 14, wherein the method allows a basis for an insurance claim as well as a precise identification listing if a sale is attempted in case of theft of one or more stamps.

20. The method of claim 14, wherein the method provides auction houses detailed information describing a collection with a single click of a button.

21. The method of claim 14, wherein the method provides a dealer buyer of a collection a digital and hard copy inventory of the collection for seamless transmission to a sales site or for hard copy price lists without additional detailed manual inputting.
